(19) United States
(12) Patent Application Publication
(10) Pub. No.: US 2007/0124226 A1
(43) Pub. Date: May 31, 2007

(54) Method for Verifying Data in a Dating Service, Dating-Service Database including Verified Member Data, and Method for Prioritizing Search Results Including Verified Data, and Methods for Verifying Data

(75) Inventor: Robert L. Garner JR., Miami Beach, FL (US)

Correspondence Address: FLEIT KAIN GIBBONS GUTMAN BONGINI & BLANCO, PL, 21355 E. DIXIE HIGHWAY, SUITE 115, AVENTURA, FL, 33180, US

(73) Assignee: GLOBAL PERSONALS, LLC, Miami, FL (US)

(21) Appl. No.: 11/672,690

(22) Filed: Feb. 8, 2007

(51) Int. Cl. G06Q 50/00

(52) U.S. Cl. 705/35

(57) ABSTRACT

An online dating service uses verified biographical data to encourage members to provide truthful biographical data and to increase members' reliance on the veracity of the information found during searches of members. In particular, the database uses verified wealth, verified professions, and verified pictures of the members. Methods for verifying biographical data utilize confirmation with third-party data and declarations by licensed professionals. A method for prioritizing search results that include verified data is also included.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to dating services and, in particular, to methods for verifying a member's wealth.

2. Description of the Related Art

From simplistic beginnings like a neighborhood matchmakers, dating services have evolved with technology like computers, the Internet, and webcams into sophisticated online databases and online communities. The technology has allowed dating services to aggregate larger number of members in their database and allows members to quickly sort through the database with sophisticated search tools to find more compatible potential couples.

Another quality of the Internet is its anonymity. Users on the Internet can participate in online communities and are not tied to their true personas. For example, a user can pretend to be a different age or pretend to have a different career than their real life. While this anonymity indulges that user's imagination, it also frustrates people who are seeking matches who truly posses those qualities. The problem of discerning truth in member profiles is often confounded by being online. In-person, there are many ways that we check each other: voice, cross-examining questions, etc. However, on the Internet, we often have to trust the truth as a person presents him or herself.

While the escapism offered by the Internet is interesting to the person who is lying, it can often lead to disappointment in the person to whom the user is lying. This problem is especially a problem in online dating. For example, a member of a dating service presents himself as a forty year old doctor who is six feet tall. Another member reads the profile and becomes interested. The two arrange to meet in person. At the date, the second user realizes that the first user is actually an unemployed sixteen year old boy. The second user will obviously be disappointed. When the lies told by the first user are more subtle, the second user may even be fooled into a deeper scam by the first person. Accordingly, a need exists for an online dating service that contains member profiles that hold true information.

In addition to having true information, a need exists to provide members of a dating service with higher quality members. “Higher quality” is very subjective, some people value wealth, others looks, and some careers. Regardless of what criteria are being valued, it is useful to provide such criteria within a database. However, screening member profiles to those values has little worth if the information in the member profiles is falsified. Therefore, there is a need to provide an online database that is searchable for truthful data.

Another problem is that members who actually have the values (i.e. criteria) that are being sought are often frustrated by unverified databases that are filled with people with falsified information. When the member database becomes full of falsified profiles, truth-telling members become frustrated because potential matches are being misdirected by members with fraudulent data. This corrupts the whole database and process because members feel there is little incentive to tell the truth and members searching have little reliance that the search results that they finding are truthful.

Published U.S. Patent Application No. US 2006/0080121 to Chiang teaches a system that verifies a user's income. Chiang teaches to contact a third party for verification. Chiang does not teach contacting CPA's, requesting bank statements, or tax returns. Chiang does not teach how to apply its verification system to a dating service wherein the members have a verified threshold amount of wealth.

Published U.S. Patent Publication No. US 2004/0128148 to Austin et al. teaches an online dating system wherein information provided by members is verified. The information includes income information by verifying tax 1040 forms. The dating system does not envision a system that sets a threshold income for its members. The system does not include verification by an accountant or account statements.

### BRIEF SUMMARY OF THE INVENTION

It is accordingly an object of the invention to provide a dating service, in particular an online dating service, with a database of verified member data, which overcomes the above-mentioned disadvantages of the heretofore-known devices and methods of this general type.

It is a further object of the invention to provide an online dating service that has members who are verified to be of a higher quality.

In its broadest form, the invention encompasses an online dating service made of a searchable database of member profiles wherein at least some of the data has been verified by corroboration that is more than the member's statement itself. Generally, the more objective the corroboration the better it is. At the same time, it is a further object of the invention for the dating service not to become overly burdened by the verification process.

With the foregoing and other objects in view there is provided, in accordance with the invention, a method for verifying wealth of members of a dating service. The method includes a subscribing and a submitting step. In the first step, a user subscribes by creating a member profile. In the member profiles, the users provide information about themselves. The member profile can also include information about what type of person the member is seeking. Usually the member profile includes biographical information like age, gender, education, interests, height, weight, and a photograph.

In the next step, at least one piece of information in the profile is verified with third party information. The information is usually in the form of third party corroboration. The corroboration might be a writing, a paper, a government document, sworn statement, or declaration that is submitted to the dating service. The corroboration can be submitted by any conventional means: i.e. email, mail, facsimile, or even telephonically.

It is a further object of the invention to provide a dating service with a wealth threshold. That is, to be a member or to be a premier member, the user must meet a wealth threshold. The dating service sets the wealth threshold. Wealth can be measured quantitatively in many ways. The invention calls for the member to first state that their wealth exceeds the threshold. Then the user submits third-party evidence such as a bank statement, tax filing, or a statement from a Certified Public Accountant (CPA) verifying the member's statement.

Wealth is a vague quality and can be measured in many ways. Financial wealth is often quantified by annual income, net worth, and savings. By using a common measurement, many members have access to the information and the dating service can verify the data more easily. The form of corroboration for wealth could be a bank statement showing a given amount, an income-tax filing showing a minimum annual income, or an accountant's statement made in their professional capacity as a CPA. Examples of tax returns that may be used include a Form 1040, a Form 1099, and a Form W-2.

A further object of the invention is to provide a method for verification, in particular wealth verification, that is not so difficult that it prevents users from verifying their information. Because most wealthy people work with a CPA, they can use a CPA to corroborate their wealth statement. However, because such statements are not traditional, it may be inconvenient, slow, and even expensive to have a CPA make the statement. To facilitate, the dating service, when prompted, may generate a form for a CPA to sign. The form can include information provided by the member. The user then simply has to print the statement, have the CPA sign it, and return the statement. Alternatively, the user can submit contact information of the CPA to the dating service and, in turn, the dating service can transmit the statement for signature by using the contact information directly to the user by mail, facsimile, or email, and have the CPA sign it directly, and return it to the dating service. To further facilitate the transaction, the dating service can generate a cover letter from the member to accompany the letter for the CPA's signature so that the CPA does not need to waste time seeking the member/client's approval for signature.

Another form of information that can be verified in a member profile of an online dating service is the profession of a member. The member profile includes a field to store a member's profession. When creating or updating their profile, the member enters their profile. Once entered, the user may choose to verify their profession. Verifying their profession allows others searching the database to find profiles that have been verified. Even if the profession is not verified, the dating service still may list members with verified professions before search results with unverified profiles. To verify their profile, the member submits professional material that includes the member's name. Professional material can be a letterhead or business card with the member's name and profession. Professional material might also be a membership card or state license. To be effective the professional material should include the member's name and profession. The member can then correlate the professional material with the name to the member profile by providing a copy of government-issued identification such as a driver's license or passport to the dating service. Once the dating service correlates the member's profession and name to an identification, the profession is verified in the database.

Probably the most commonly falsified part of a member profile is the photograph. The member posts a photograph that is someone else. This can reach the extremes of someone posting the photograph of someone much younger or even the opposite sex. The invention provides a method for the member verifying that the photograph in the member profile belongs to the member.

To verify the photo of a member profile, the first step is creating a member profile for the given member in the dating service database. The member profile includes a field for storing at least one picture of the member. For electronic, online dating services, the member uploads their digitized photograph file (i.e. jpeg, gif, etc.) to the online database.

The next step of picture verification is for the member to submit a copy of a piece of identification that includes a photograph. Preferably, the identification is government issued, like a driver's license or a passport. For an online database, the user would scan their identification and then upload it to the online dating service.

To complete the verification, the photograph submitted is matched to the photograph on the identification. While many face matching techniques exist, the simplest for of matching would be to have an employee of the dating service matching the photograph to the identification.

When searching the database of the online dating service, a user can limit the search to member profiles that have verified photographs. To reward users who have verified their pictures, matches with verified pictures can be listed before member profiles that have pictures that are not verified.

It is a further object of the invention to provide a dating service that includes a searchable database of member profiles that can store if a member has been verified to meet a given criteria (i.e. a verified wealth threshold, a verified profession, and/or a verified photograph). In its preferred form, the dating service and database are hosted on a computer. The computer is connected to or includes a web server that connects the database to members over a computer network. The computer network is preferably an IP protocol network such as the Internet. A profile that has an indicator that the member has been verified as having met a criteria is storable in each user profile. The verification methods are detailed elsewhere in this application. The member profiles forming the dating base can include, in combination or without, a verified wealth, a verified profession of the associated member, and a verified picture.

The invention of the instant application also encompasses a method displaying search results of the member database that gives priority to member profiles that include verified information. A plurality of member profiles is placed in the database. The member profiles are formed with at least one searchable field. The data being searched for is a profile criterion. The member profiles are filled with criteria by the members. A member who wants to search the database for possible matches then enters at least one criterion. Search results of member profiles that match the at least one criterion are displayed. Member profiles that have verified criteria or criterion are displayed before matching profiles that are not verified. The criteria being searched does not necessarily need to be the verified criteria to give the results precedence. For example, a user might be search for men who are six feet tall. The member profiles of men who are six feet tall are displayed. However, the matching member profiles with a verified criterion (e.g. verified wealth, verified profession, or verified picture) are listed first. By listing member profiles that are verified before other profiles, members are given incentives to have their member profiles verified. In addition, users who are searching will not waste time viewing unverified profiles.

Other features which are considered as characteristic for the invention are set forth in the appended claims.

Although the invention is illustrated and described herein as embodied in a method for verifying data in a dating service and a dating-service database including verified member data, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flowchart of a method for verifying wealth of members of a dating service.

FIG. 2 is a flowchart of a method for creating a member profile in a dating service.

FIG. 3 is a flowchart of a method for verifying personal information in a member profile in a dating service.

FIG. 4 is a schematic view of a computer network connecting users to an online dating service.

FIG. 5 is a screenshot of a user profile in an online dating database.

### DETAILED DESCRIPTION OF THE INVENTION

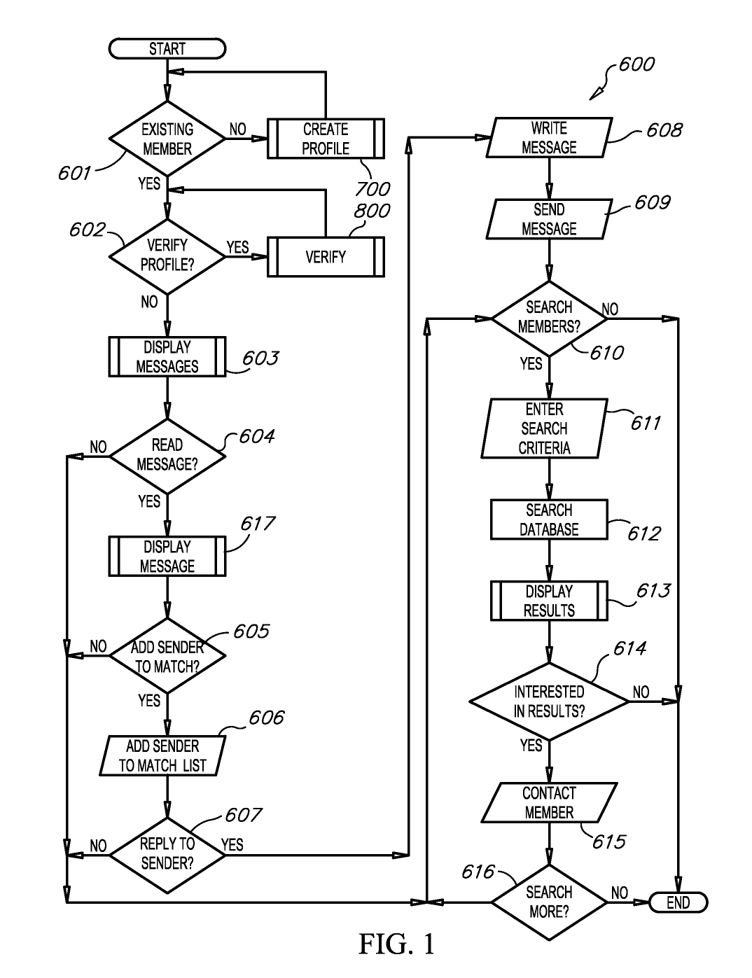

Referring now to the figures of the drawing in detail and first, particularly, to FIG. 1 thereof, there is seen a flowchart depicting a method for verifying personal information in member profiles within an online database of an online dating service.

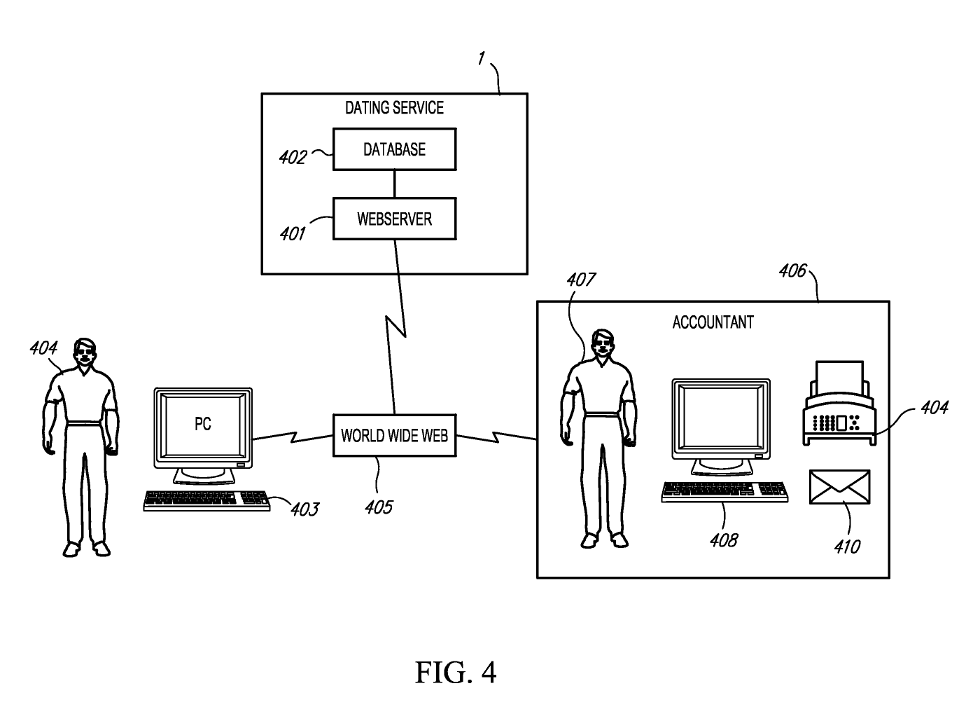

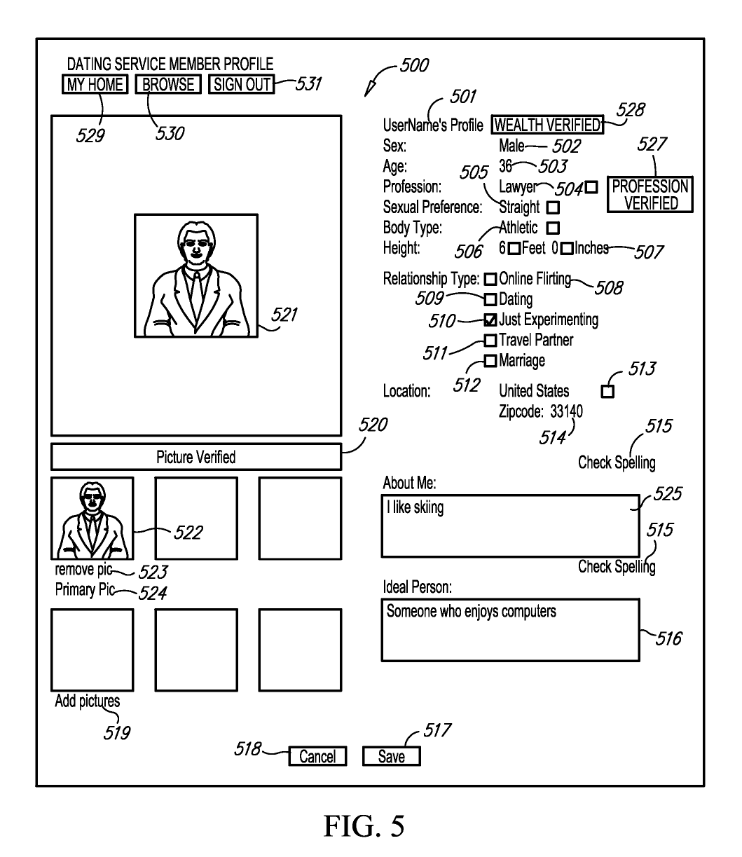

The method shown in the flowchart in FIG. 1 is executed in a computer application that is run by a web server 401, which is shown in FIG. 4. The web server 401 manipulates, searches, uses, changes, and creates data (i.e. member profiles 500) in a connected electronic computerized database 402. The database 402 stores member profiles 500, as shown in FIG. 5, of members of an online dating service.

FIG. 5 shows a typical member profile 500. The member profile is a data record made of a plurality of searchable fields that hold biographical data about the respective member. Each member profile 500 includes a username 501, which is unique within the database 402, i.e. a prime key. Other prime keys are possible. The gender 502, age 503, sexual preference 505, body type 506, height 507, relationship type (i.e. online flirting 508, dating 509, just experimenting 510, travel partner 511, and marriage 512), location 513, and zip code 514. A text field called “About me” 525 allows the members to enter text and describe themselves. A text field called “Ideal Person” 516 allows the members to enter text and describe what qualities they seek in others. A check spelling button 519 is included to check the spelling of the text with the ideal-person field 516 and the about-me field 525 are also included in the member profile 500. The member 1 associated with the profile 500 can save the changes to the profile by selecting the save button 517 or not make the changes by selecting the cancel button 518. Lastly, navigation buttons for online browsing are included: my-home button 529, browse button 530, and sign-out button 531.

A wealth verification indicator 528 indicates if the member's wealth meets a threshold set by the online dating service and that the wealth has been verified with a statement such as a declaration or affidavit by a Certified Public Accountant, a bank statement, or a signed income tax return. The wealth verification method is detailed below.

A profession field 504 stores the member's profession. A profession verification indicator 527 shows if the profession listed in the profession field 504 has been verified or if the profession listed is unverified. The method for profession verification is detailed below.

A photograph 522 can be uploaded to the database 402. A photograph 522 that has been identified (i.e. “pic verified”) as the user by having a third party compare the user's real name (which is stored but not displayed publicly) and a government-issued photo identification such as a driver's license or passport to confirm that the photograph 522 belongs to the member. A photograph 522 can be promoted to be a primary photograph 521 of the profile 500 by selecting the primary photograph button 524. A photograph 522 can be deleted from the profile 500 by selecting the remove photograph button 523.

FIG. 1 depicts a method for searching a database 402 of member profiles 500 in an online database 402 of an online dating service. FIG. 4 depicts a simple embodiment of a computer network. In this preferred embodiment, the user 404 operates a personal computer 403 with a web browser (not shown) to browse the Internet 405 (i.e. worldwide web) to reach a web server 401 hosting the database 400; see step 600. In step 601, the dating service asks if the user 404 is an existing member. If the user 404 is not, the user 404 is referred to the create profile subroutine 700. If the user 404 has a member profile 500, in step 602, the web server 401 checks if the member profile 500 of the user is verified. If the member profile 500 is unverified, the web server 401 queries the user 404 if the user 404 wants to verify his or her member profile 500. If the user 404 chooses to verify the profile 500, the user 404 is referred to the verification subroutine 800.

In step 603, messages sent to the user 404 are displayed. In step 604, the user 404 can choose to read a given message. In step 617, if chosen to be read, the message is displayed to the user 404. In step 605, the user 404 can choose to add the sender to the user's match list. In step 606, when the user 404 chooses to add a user to the user's match list, the relationship between the user's member profile 500 and the selected member's profile 500 is stored in the database 402. In step 607, the user 404 can choose to send a reply message to the user. In step 608, the user 404 enters the message on the personal computer 403 and, in step 609, the message is sent from the personal computer 43 via the Internet 405 to the web server 401 and stored in the database 402.

In step 610, the user 404 is asked if the user 404 wants to search the database 402. If the user 404 chooses to search the database 402, the user 402 enters criteria in step 611. Examples of criteria are gender 502, age 503, sexual preference 505, body type 506, height 507, relationship type, location 513, zip code 514, strings of text in the about-me field 525, and a string of text in the ideal person field 516. General database search principles are applicable such as fuzzy logic, ranges of inputs, connectors (i.e. and, or, not, exactly, etc.), wildcards, and ranking of results are included to provide sophisticating search capabilities. In addition, the user 404 can request to show only member profiles 500 with a picture verification 520, a job verification 527, and/or a wealth verification 528. In step 612, the database 402 is searched for member profiles 500 with matching criteria. In step 613, the member profiles 500 that match the criteria are displayed on the personal computer 403 of the user 404. In step 614, the system asks if the user 404 is interested in the user profile being displayed. If the user 404 is interested, in step 615, the user associated with the member profile 500 is notified that the user 404 is interested in meeting them; a message can be added long with the member profile 500 of the user 404.

In step 616, the user is asked if the user 404 wants to search more. If yes, the user 404 is returned to step 613, and the next matching results are displayed. If the user 404 chooses not to search further, the process ends. The user might choose to enter a new search and move to step 611 or to read messages in step 604, or verify their account through subroutine 800.

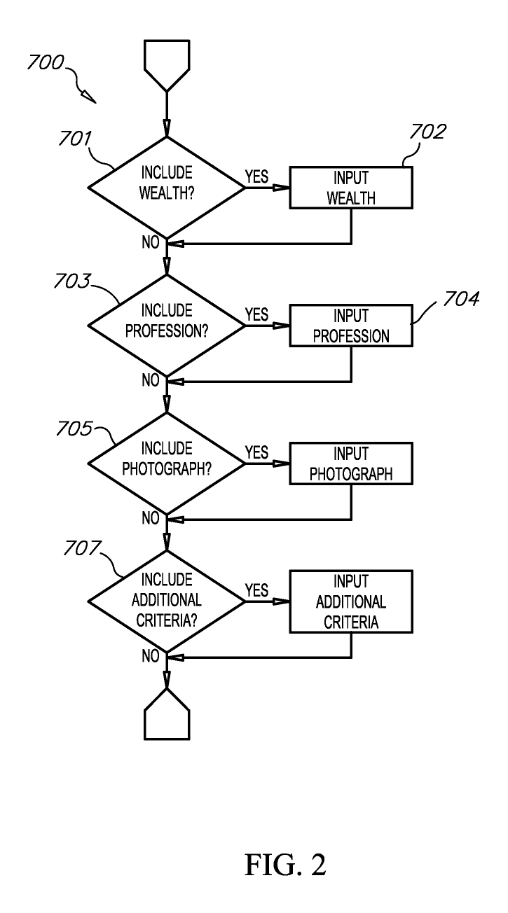

FIG. 2 depicts the create profile subroutine 700. In step 701, the user 404 can add their wealth to their profile 500. If chosen, in step 702, the user 404 inputs their wealth. Because wealth can be measured in many ways, income, net worth, assets, the dating service 1 can provide choices for the user to categorize the type of wealth and the amount. For example, “Annual income of at least $100,000” or “Net worth of $1 million” or “Savings of $1 million” can be chosen.

In step 703, the user 404 is asked if the user wants to include their profession in their user profile 500. In step 704, the user inputs their profession. The input can be text data or be a drop box selection from a pre-propagated list of professions, for example, doctor, lawyer, accountant, banker, stockbroker, computer programmer, or patent examiner.

In step 705, the web server 401 queries the user 404 if the user wants to include a photograph in the member profile 500. If the user answers yes, then the web server 401 uploads a photograph from the user 402 in step 706. After the photograph has uploaded or if the user 402 chooses not to include a photograph, the web server 401 advances to step 707.

In step 707, the web server 401 queries the user 404 if the user 404 wants to include additional data to the user's member profile. The additional data can include username 501, gender 502, age 503, profession 504, sexual preference 505, body type 506, height 507, online flirting 508, dating 509, just experimenting 510, travel partner 511, marriage 512, location 513, zip code 514, about me 525, and ideal person 516. After the additional data has been entered or if the user 404 chooses not to add data, the create profile subroutine 700 ends.

Once the user has a profile (either already existing or recently created, i.e. create profile subroutine 700), the web server 401 asks the user 404 if the user wants to verify the member profile 500. If the user 404 elects to verify the member profile 500, the web server 404 executes the verify subroutine 800.

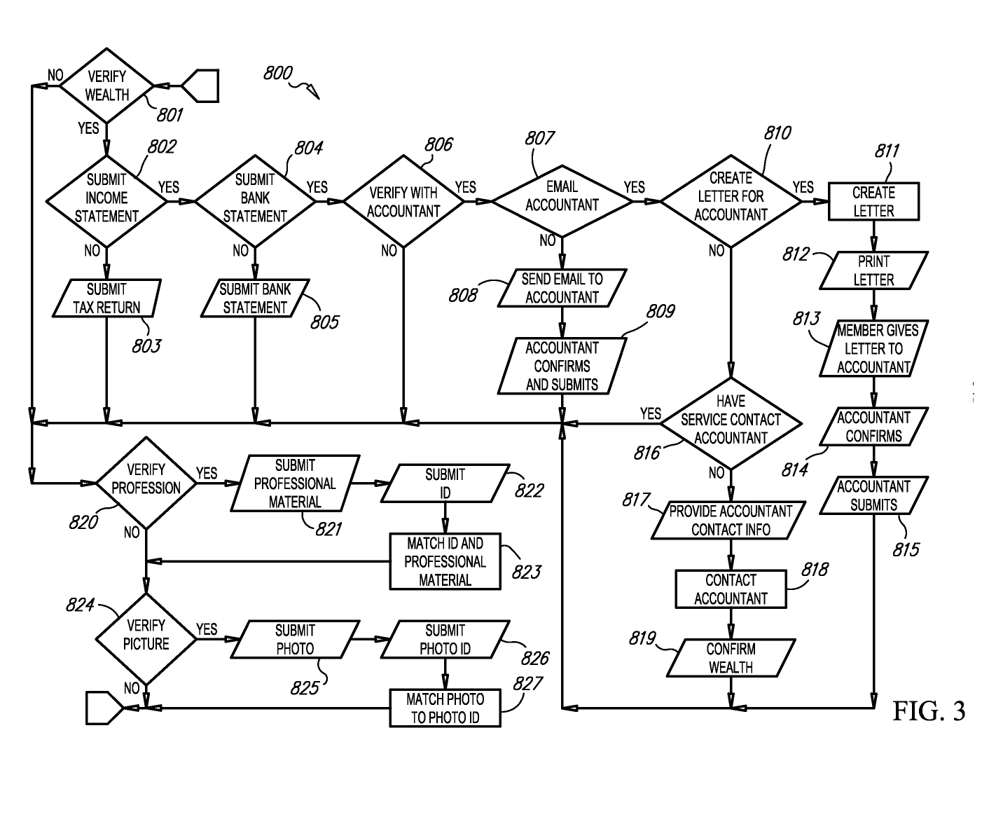

FIG. 3 shows a flowchart of the verify subroutine 800. In step 801, the web server 401 queries the user 402 to verify the wealth input in step 702. If the user 404 chooses to verify the wealth, the user 404 is asked in step 802 if the user 404 wants to verify the user's wealth by submitting an income statement. If the user 404 wants to submit an income statement, in step 803, the user uploads a scanned image of a signed tax return verifying the wealth by showing an amount of income. If the user 404 does not choose to submit an income statement in step 802, the user can choose to submit a bank statement in step 804. If the user 404, chooses to submit a bank statement, the user uploads a scanned image of a bank statement showing a balance to prove the wealth in step 805.

In step 806, the user 404 is asked to verify the user's wealth by verifying it with an accountant. In step 807, the user is asked if they want to verify the user's wealth by sending an email to the user's accountant 407. If the user 404 chooses to use email, then in step 808 an email message is sent to the user's accountant 407. The information about the user 404 and the accountant 407 are propagated in a prewritten form email. The email includes a statement that the accountant 404 is making a sworn declaration as a certified public accountant that the user 404 has the stated wealth. In step 809, the certified public accountant executes the statement to verify the wealth and returns the letter to the web server 401 via email.

If electronic email is not selected in step 807, the user 404 is asked if the user will verify the user's wealth with a letter 410 from an accountant in step 810. In step 811, the user 404 inputs information about the user 404 and the accountant 407, in particular the user's and accountant's name and address. From this information, a form letter 410 is generated. In step 812, the user 404 prints the letter 410. In step 813, the user 404 delivers the letter 410 to the accountant 407. In step 814, the accountant 407 signs the letter 410 to confirm the wealth of the user 404. In step 815, the accountant returns the signed letter 410 to the online dating service 1. The online dating service 1 enters a wealth verification 528 in the user's profile 500 if the statement verifies that the user 404 meets the wealth threshold. The online dating service 1 may need to re-contact the user 404 or accountant 407 to complete the verification.

If the user 404 chose in step 810 not to have a letter 410 created for the client, then, in step 816, the user 404 is asked if the service 1 should contact an accountant. If the user 404 answers no, then the verify wealth subroutine is ended. If the user 404 answers yes, then the user is asked to provide accountant contact information in step 817. Accountant contact information can include the accountant's address, telephone number, facsimile number, and email address. In step 818, the dating service 1 contacts the accountant, for example, by telephone, facsimile, mail, or e-mail and provided with a statement of the user's wealth. The statement can be in the form of a stated minimum for the dating service 1. For example, the statement might say, “I confirm that I am a certified public accountant and that I confirm that the user made at least $x last year.” In step 819, the accountant is asked to confirm the user's wealth by verifying their status as a certified public accountant and signing the statement as a certified public accountant.

After the wealth is verified or if the user chooses not verify the user's wealth, the user is asked if the user wants to verify the user's profession in step 820. If the user chooses to verify their profession, in step 821, the user submits professional material. The material can be professional letterhead, a state sanctioned (i.e. a state bar association or medical license) certification, or other material showing the profession of the user. Typically the materially is submitted by scanning it and submitting it electronically, faxing it to the dating service 1, or mailing a copy to the dating service 1. In step 822, the user includes a government identification that matches the material submitted in step 821. In step 823, the dating service 1 matches the professional material submitted in step 821 to the identification submitted in step 822. Upon successful matching, the member profile 500 has a job verification 527 added to the member profile 500.

In step 824, the user is asked if the user wants to verify the user's picture. If the user chooses to verify the user's picture, then the user submits a photograph in step 825. In step 826, the user submits identification with a photograph. Preferably, the identification is state sanctioned: i.e. a driver's license or passport. In step 827, the dating service 1 verifies the picture submitted in step 825 by matching it to the photograph in the photo id submitted in step 826.

If the user chooses not to verify the user's picture in step 825, the verification subroutine 800 is ended.

The database 402 of the dating service 1 can be searched and the results are prioritized if the results contain verified data; i.e. a wealth verification 528, a profession verification 527, and/or a picture verification 520. The database 402 includes fields that store biographical data about the respective members. A user, preferably a member, searches the database 402 by entering a criterion. Search results include member profiles 500 that match the criterion. Member profiles 500 that include verified biographical data (i.e. a wealth verification 528, a profession verification 527, and picture photograph 520) are given precedent over matching member profiles 500 that do not include verified biographical data. The search criterion can be for biographical data other than the wealth verification and the results are still given precedent when the member profiles 500 include verified biographical data.

We claim:

1. A method for verifying wealth of members of a dating service, which comprises:
subscribing a member in a dating service, said dating service having a wealth threshold; and
submitting a statement verifying the member meets said wealth threshold of said dating service.

2. The method according to claim 1, wherein the submitting step includes faxing said statement to the dating service.

3. The method according to claim 1, which further comprises using an annual income as said wealth threshold.

4. The method according to claim 3, which further comprises using a tax return as said statement.

5. The method according to claim 4, which further comprises selecting said tax return from the group consisting of a Form 1040, a Form 1099, and a Form W-2.

6. The method according to claim 1, which further comprises:
using a bank statement amount as said wealth threshold; and
using a bank account balance showing at least said bank account balance.

7. The method according to claim 1, which further comprises:
sending said statement to an accountant of the member, said statement requesting the accountant to confirm said wealth threshold; and
executing said statement by the accountant before submitting said statement to the dating service.

8. The method according to claim 1, which further comprises:
sending said statement to the member, said statement requesting an accountant to confirm said wealth threshold; and
executing said statement by the accountant before submitting said statement to the dating service.

9. The method according to claim 7, which further comprises requesting contact information of the accountant before sending said statement.

10. The method according to claim 9, which further comprises obtaining permission from the member to contact the accountant before sending said statement.

11. The method according to claim 1, which further comprises:
creating a profile for the member including a profession;
submitting professional material and identification of the member; and
verifying said profession of the member by matching the identification, the professional material, and the profession of the member.

12. The method according to claim 11, which further comprises selecting said professional material from the group consisting of a business card and a company letterhead naming the member.

13. The method according to claim 11, which further comprises requiring government-issued identification as said identification.

14. The method according to claim 13, which further comprises selecting said government-issued identification from the group consisting of a driver's license and a passport.

15. The method according to claim 1, which further comprises:
creating a profile for the member including a photograph;
submitting photo identification of the member; and
verifying said photograph by matching the photo identification to the photograph of the member.

16. The method according to claim 15, which further comprises requiring government-issued identification as said identification.

17. The method according to claim 16, which further comprises selecting said government-issued identification from the group consisting of a driver's license and a passport.

18. A dating service, comprising a searchable database including a member profile having a field for storing a wealth verification when a member associated with said member profile has been verified to meet a wealth threshold.

19. The dating service according to claim 18, wherein said searchable database is online and searchable by members connected by a computer network.

20. The dating service according to claim 18, wherein said member profile includes a field for storing a profession of the member associated with said member profile and a field for storing a profession verification when the member associated with said member profile has been verified to work in the profession.

21. The dating service according to claim 18, wherein said member profile includes a field for storing a photograph of the member associated with said member profile and a field for storing a picture verification when the member associated with said member profile has been verified to have a photo identification matching said photograph.

22. A method of listing search results of the database according to claim 18, which comprises:
including a plurality of the member profiles in the database;
including a searchable field in each of the member profiles, said searchable field holding biographical data about the member associated with a respective one of the member profiles;
entering a search criterion to be found in the searchable field;
displaying the member profiles having biographical data matching the search criterion; and
displaying the matching member profiles with wealth verifications before other matching member profiles.

23. A method for verifying a profession of a member of a dating service, which comprises:
subscribing a member in a dating service;
creating a profile for the member including a field for storing a profession of the member and a field for storing a profession verification;
submitting a profession to be stored in the field for storing the profession;
submitting professional material and identification of the member; and
storing a profession verification in the field for storing the profession verification when the profession has been verified by matching the identification, the professional material, and the profession of the member.

24. The method according to claim 23, which further comprises selecting said professional material from the group consisting of a business card and a company letterhead naming the member.

25. The method according to claim 23, which further comprises requiring government-issued identification as said identification.

26. The method according to claim 25, which further comprises selecting said government-issued identification from the group consisting of a driver's license and a passport.

27. A method for verifying a photograph of a member of a dating service, which comprises:
subscribing a member in a dating service;
creating a profile for the member including a field for storing a photograph and a field for storing a picture verification;
storing a photograph of the member in the field for storing a photograph;
submitting a photo identification of the member; and
storing a picture verification in the field for storing the picture verification when the photographs has been verified by matching the photo identification to the photograph of the member.

28. The method according to claim 27, which further comprises requiring government-issued identification as said identification.

29. The method according to claim 28, which further comprises selecting said government-issued identification from the group consisting of a driver's license and a passport.
